(19) United States
(12) Patent Application Publication
(10) Pub. No.: US 2022/0192115 A1
(43) Pub. Date: Jun. 23, 2022

(54) PLANT CULTIVATION APPARATUS

(71) Applicant: LG Electronics Inc., Seoul (KR)

(72) Inventors: Mina YANG, Seoul (KR); Youngsuk KIM, Seoul (KR)

(21) Appl. No.: 17/559,466

(22) Filed: Dec. 22, 2021

(30) Foreign Application Priority Data
Dec. 22, 2020 (KR) 10-2020-0181108

(51) Int. Cl. A01G 31/02

(52) U.S. Cl. CPC A01G 31/02

(57) ABSTRACT

A plant cultivation apparatus includes a cabinet, a bed disposed in the cabinet, a cultivator configured to be disposed on the bed and accommodate a cultivation medium therein, and a water supply configured to supply water to the cultivator. The cultivator includes a cultivation vessel that is configured to be disposed on the bed and defines a cultivation medium receiving space configured to accommodate the cultivation medium, and a nutrient feeder that is disposed in the cultivation medium receiving space and spaced apart from a bottom surface of the cultivation vessel, where the nutrient feeder is configured to accommodate a nutrient for the plant. The cultivator is configured to bring the water inside the cultivation medium receiving space into contact with the nutrient of the nutrient feeder and to supply the nutrient mixed with the water to the cultivation medium.

### CROSS-REFERENCE TO RELATED APPLICATIONS

This application claims the benefit of Korean Patent Application No. 10-2020-0181108, filed on Dec. 22, 2020, which is hereby incorporated by reference as when fully set forth herein.

### TECHNICAL FIELD

The present disclosure relates to a plant cultivation apparatus, and more particularly, to a plant cultivation apparatus including a nutrient feeder that accommodates a nutrient for a plant.

### BACKGROUND

A plant cultivation apparatus refers to an apparatus that can perform plant cultivation by supplying light energy, moisture, soil, and temperature for plant growth. For example, the plant cultivation apparatus may have a predetermined cultivation space defined therein, provide an environment suitable for plant growth, and cultivate and store the plant in the predetermined cultivation space.

In some cases, the plant cultivation apparatus may include components for supplying moisture and nutrients for plant growth. Further, the plant cultivation apparatus may include a component for artificially supplying light energy. In some cases, the plant cultivated in the plant cultivation apparatus may be supplied with light energy from the plant cultivation apparatus, not from the sun outside the plant cultivation apparatus.

In some examples, a user may not periodically supply moisture or nutrient in a cultivation operation process of the plant. The plant cultivated in the plant cultivation apparatus may grow upon receiving the nutrient, moisture, and light energy supplied from the plant cultivation apparatus.

A water-based cultivation scheme refers to a scheme for cultivating a plant by supplying to the plant a cultivation medium in which inorganic nutrients for growth are dissolved in water, instead of using soil. The water-based cultivation scheme may be more hygienic than the soil-based cultivation scheme using soil, and may be less affected by weather and season. Thus, the water-based cultivation scheme may create a more favorable growth condition than the soil-based cultivation scheme may.

A hydroponic water-based cultivation scheme is one of the water-based cultivation schemes in which the plant is cultivated so that the roots thereof are received in nutrient liquid, and a stem and leaves of the plant are grown in a space above the nutrient liquid.

In this hydroponic water-based cultivation scheme, the nutrient liquid containing nutrients therein may be stored in a storage tank, and the nutrient liquid may be supplied to a pod where the plant is cultivated, so that the plant is grown while the plant's roots are received in the nutrient liquid.

In some cases, a nutrient amount may increase according to a growth period of the plant, and the nutrient amount may vary based on a plant type.

In some cases, for certain types of plants, a nutrient concentration may be controlled based on growth periods. For plants such as fruits and vegetables, the nutrient concentration may be controlled such that a growth state changes from vegetative growth to reproductive growth. In some cases, it may cause inconvenience for the user to additionally control the nutrient concentration based on plant types to be cultivated and based on growth stages.

Therefore, it may be important to design a structure that can additionally supply the nutrients based on the type of the plant and the growth stages using water supplied from the storage tank to the pod.

### SUMMARY

The present disclosure describes a plant cultivation apparatus that can supply nutrients based on a type of a plant or growth stages.

The present disclosure further describes a plant cultivation apparatus that includes a cultivator including a nutrient feeder in which nutrient for the plant is received, thereby improving convenience of a user.

The present disclosure further describes a plant cultivation apparatus that includes a water supply for supplying water to a cultivator and to a nutrient feeder including nutrient to be fed to the cultivator.

The present disclosure further describes a plant cultivation apparatus that can vary a vertical level of a water surface inside a cultivator to supply water to a nutrient feeder such that the nutrient for the plant is supplied to a cultivation medium.

The present disclosure describes a plant cultivation apparatus that can have an additional supply channel for supplying water to a nutrient feeder, where the additional supply channel can supply water to the nutrient feeder such that the nutrient for the plant is fed to the plant.

According to one aspect of the subject matter described in this application, a plant cultivation apparatus includes a cabinet, a bed disposed in the cabinet, a cultivator configured to be disposed on the bed and to accommodate a cultivation medium therein, where the cultivation medium is configured to accommodate at least portion of a plant. The plant cultivation apparatus further includes a water supply disposed at the cabinet and configured to supply water to the cultivator. The cultivator includes a cultivation vessel that is configured to be disposed on the bed and defines a cultivation medium receiving space configured to accommodate the cultivation medium, where the cultivation vessel is configured to receive water supplied from the water supply and to supply the water to the cultivation medium in the cultivation medium receiving space. The cultivator further includes a nutrient feeder that is disposed in the cultivation medium receiving space and spaced apart from a bottom surface of the cultivation vessel, where the nutrient feeder is configured to accommodate a nutrient for the plant. The cultivator is configured to bring the water inside the cultivation medium receiving space into contact with the nutrient of the nutrient feeder and to supply the nutrient mixed with the water to the cultivation medium.

Implementations according to this aspect can include one or more of the following features. For example, the water supply can include a first water supply channel that extends toward the bed and configured to discharge water to the cultivation vessel, and the cultivation vessel can define a first communication hole configured to supply the water discharged from the first water supply channel into the cultivation medium receiving space. In some examples, the nutrient feeder can define a nutrient feeding hole that is in fluid communication with an inside of the nutrient feeder and the cultivation medium receiving space, where the nutrient feeding hole is configured to supply the water in the cultivation medium receiving space into the inside of the nutrient feeder to thereby mix the water with the nutrient.

In some implementations, the cultivation vessel can have an open top that exposes the cultivation medium receiving space therethrough, where the cultivator can further include a cover configured to be disposed on the open top of the cultivation vessel and to cover the cultivation medium receiving space. The cover can have a cover channel defined at a top surface of the cover and configured to receive the water supplied from the water supply, and a first inflow hole that is defined in the cover channel and in fluid communication with the inside of the nutrient feeder, where the first inflow hole is configured to supply the water to the nutrient feeder. In some examples, the cover channel can be recessed from a portion of the top surface of the cover, and the cover can further include a cultivation medium receiving portion that is disposed in the cover channel, that protrudes upward relative to a bottom surface of the cover channel, and that is configured to accommodate an upper end of the cultivation medium in the cultivation medium receiving space. In some examples, at least a portion of the first inflow hole can be defined by the bottom surface of the cover channel.

In some examples, the nutrient feeder can be disposed at the cover and is spaced apart from the cultivation medium receiving portion, and the first inflow hole can be defined at a periphery of the nutrient feeder. In some implementations, the nutrient feeder can include a side surface that extends from the cover toward the bottom surface of the cultivation vessel and a bottom portion that is connected to the side surface and defines a nutrient feeding hole in fluid communication with the cultivation medium receiving space, where the first inflow hole passes through the side surface of the nutrient feeder and is in fluid communication with the inside of the nutrient feeder. In some examples, the water supply can further include a second water supply channel that is located above at least a part of the cover channel and configured to supply water to the cover channel to thereby supply the water to the nutrient feeder through the first inflow hole.

In some implementations, the plant cultivation apparatus can further include a controller configured to control the water supply, where the controller is configured to, in a general mode, control the water supply to supply water to the cultivation medium receiving space through the first water supply channel to thereby raise a water surface of water in the cultivation medium receiving space to a first level that is lower than a vertical level of the nutrient feeder such that the nutrient feeder is positioned above the water surface. In some examples, the water supply can be configured to supply water to the cultivator selectively through one of the first water supply channel or the second water supply channel, and the controller can be configured to, in the general mode, block the second water supply channel and control the water supply to supply water to the cultivation medium receiving space through the first water supply channel.

In some implementations, the controller can be configured to, in an additional water supply mode, control the water supply to supply water to the cultivation medium receiving space through the first water supply channel to thereby raise the water surface in the cultivation medium receiving space to a second level that is higher than or equal to a vertical level of the nutrient feeding hole such that the nutrient of the nutrient feeder is mixed with the water supplied through the nutrient feeding hole and fed to the cultivation medium. In some examples, the controller can be configured to, in an upper water supply mode, block the first water supply channel and control the water supply to supply water to the cover channel through the second water supply channel to thereby supply the water to the nutrient feeder through the cover channel such that a mixture of the water and the nutrient in the nutrient feeder is supplied to the cultivation medium.

In some implementations, the water supply can include a pipe that is made of metal. In some implementations, the cultivation vessel can define a communication hole at the bottom surface and an open top facing the bottom surface, where the communication hole is in fluid communication with the cultivation medium receiving space. In some examples, the water supply can include a first pipe configured to supply water to the communication hole to thereby raise a water surface of water in the cultivation vessel above a bottom of the nutrient feeder, and a second pipe configured to supply water to the nutrient feeder through the open top of the cultivation vessel while the water surface of water in the cultivation vessel is lower than the bottom of the nutrient feeder.

In some examples, the cultivator can further include a cover configured to cover the open top of the cultivation vessel, where the cover defines a cover channel recessed from an upper surface of the cover toward the bottom surface and configured guide the water supplied through the second pipe toward the nutrient feeder. In some examples, the cultivator can be configured to accommodate the cultivation medium vertically between the cover and the cultivation vessel.

In some implementations, the nutrient feeder can be recessed from the upper surface of the cover and spaced apart from the cover channel, and the cover can further define a first inflow hole that is in fluid communication with the nutrient feeder and the cover channel. In some examples, the bottom of the nutrient feeder can be disposed vertically below a bottom surface of the cover channel.

Effects of the implementations of the present disclosure are not limited to those as described above, and other effects as not mentioned above can be clearly recognized by those skilled in the art based on following descriptions.

### BRIEF DESCRIPTION OF THE DRAWINGS

FIG. 1 is a perspective view showing an example of a plant cultivation apparatus.

FIG. 2 is a perspective view showing an example of a door of the plant cultivation apparatus.

FIG. 3 is a perspective view showing an example of a cultivator that is seated on an example of a bed of the plant cultivation apparatus.

FIGS. 4A and 4B are a perspective view and an exploded view showing example components of the cultivator.

FIG. 5 is a side view showing an example of the cultivator including a nutrient feeder.

FIG. 6 is a perspective view showing an example of a cultivator seated on the bed of the plant cultivation apparatus.

FIG. 7 is an exploded view showing an example of a cultivator.

FIG. 8 is a perspective view showing an example of a cultivator.

FIGS. 9A and 9B are a top view and a side view showing an example of a cultivator.

FIGS. 10A to 10D are views showing an example of a water supply process of the plant cultivation apparatus.

FIG. 11 is a diagram showing an example of a control mode performed by a controller of the plant cultivation apparatus.

### DETAILED DESCRIPTION

Hereinafter, one or more implementations of the present disclosure will be described in detail with reference to the accompanying drawings. The same reference numbers can be allocated to the same or similar components. Redundant descriptions thereof will be omitted.

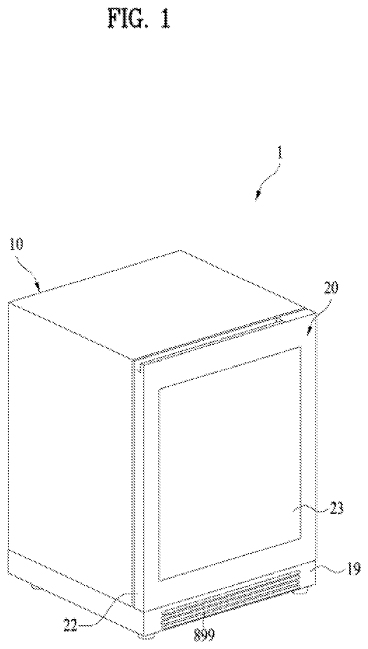

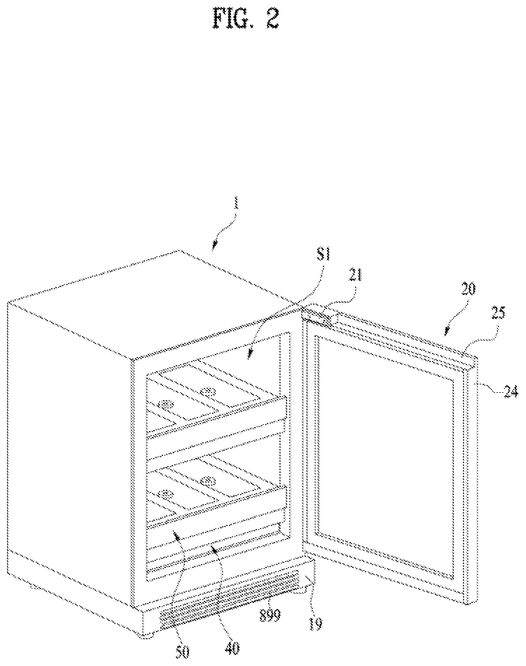

FIG. 1 is a perspective view showing an example of a plant cultivation apparatus 1. FIG. 2 is a perspective view showing an example of a door 20 of the plant cultivation apparatus 1.

In some implementations, as shown in FIG. 1 and FIG. 2, the plant cultivation apparatus 1 can include a cabinet 10 having a cultivation space S1 defined therein in which a plant is cultivated, and the door 20 for opening and closing the cabinet 10. An outer appearance of the plant cultivation apparatus 1 can be defined by the cabinet 10 and the door 20. The plant cultivated in the cultivation space S1 can be of a type of a plant that can be eaten by a user, can be easily cultivated, and may not occupy a lot of space, such as leafy vegetables and herbs.

The cabinet 10 can have one open face having an opening defined therein. The cultivation space S1 can be defined in the cabinet 10. The cabinet 10 can have a rectangular parallelepiped shape as shown in the drawing, but is not necessarily limited thereto. The cabinet 10 can be formed in various forms such as a cylinder and a sphere as long as the cultivation space S1 can be defined therein. Further, as shown in FIG. 1 and FIG. 2, the door 20 can be sized to shield the opening of the cabinet 10. Hereinafter, for convenience of descriptions, the open face defines a front face of the cabinet 10. However, the disclosure is limited thereto.

The door 20 can have a door panel 23 which is at least partially transparent. The door panel 23 can be made of a glass or a transparent plastic material such that the user can see through the door panel 23 into an inside of the cabinet. Due to this structure, the user can visually identify the inside of the cultivation space S1 even when the door 20 is closed, so that a growth state of the plant can be identified by the user. Further, interior effects can be derived. When the identification of the inside of the cabinet is unnecessary, a neat outer appearance of the apparatus can be maintained.

In some cases, a colored coating or a vapor deposited film can be attached to the door panel 23. Thus, the door panel 23 can be constructed such that the cultivation space S1 is selectively visible or invisible to the user.

In some implementations, the door 20 can include a door frame 22 that constitutes a perimeter of the door. A central portion of the door frame 22 can be opened to define an opening. The door panel 23 can be constructed to shield the opening of the door frame 22.

Further, the door 20 can include a door sealing 24 disposed on one face of the door frame 22 facing toward the cabinet 10 and disposed along a perimeter of the opening of the door frame 22. The door sealing 24 can absorb an impact force exerted from the door 20 onto the cabinet 10 when the door 20 is closed, thereby improving durability and reliability of the plant cultivation apparatus 1. Further, the door sealing 24 can prevent air flow from the cultivation space S1 and the cabinet 10 to the outside so that a temperature and a humidity of the cultivation space S1 can be kept constant. Further, the door sealing 24 can be made of an insulating material so that the cabinet 10 can be thermally insulated. Accordingly, the cultivation space S1 can maintain a temperature thereof set by the user.

In some examples, the door 20 can have a door coupler 21 disposed on one side of the door frame 22 and coupled to the cabinet 10. As shown in FIG. 1 and FIG. 2, the door coupler 21 can be disposed on one side of left and right sides of the door frame 22. Accordingly, the door can be opened and closed in one direction of left and right directions around the user, thereby increasing the user's convenience. Further, the door 20 can be pivotably coupled to the cabinet 10 via the door coupler 21.

The cultivation space S1 can be opened and closed according to pivoting of the door 20. Further, the door 20 can have a door handle 25 disposed at one of an upper end and a lower end of the door frame 22. The user can hold the door handle 25 to open and close the door 20. When the door coupler 21 is disposed on one side of the left and right sides of the door frame 22, the door handle 25 can be disposed on the other side of the left and right sides of the door frame 22. For example, the door coupler 21 can include a hinge.

In some examples, a lower cabinet 19 can constitute a bottom portion of the cabinet 10. The lower cabinet 19 can receive an air adjuster therein that receives outside-air and supplies the outside-air to the cultivation space S1.

In some implementations, the plant cultivation apparatus 1 can include a plurality of beds 50 that are vertically arranged inside the cabinet 10. For instance, two beds 50 can be respectively disposed in an upper portion and a lower portion of the cabinet 10. Hereinafter, for convenience of description and understanding, the two beds 50 can be referred to as an upper bed 50 and a lower bed 50, respectively. In another example, at least three or more beds 50 can be arranged depending on a size of the cabinet 10.

Further, a plurality of cultivators 60 containing plant seeds and nutrients for cultivation can be seated on a top face of the bed 50. Thus, the bed 50 can be referred to as a shelf or a tray. The interior of the cabinet 10 can act as the cultivation space S1 in which the plant is cultivated.

The cultivator 60 can be provided to be adapted to a combination of various kinds of seeds and corresponding nutrients. The user can select the cultivator to be adapted to a target plant type for cultivation. Further, the bed 50 can have a structure on which the cultivator 60 can be seated and by which a seating state thereof can be maintained.

Further, as will be described later, the bed 50 can have a communication channel 41512 defined therein through which water supplied from a water supply 40 flows. In some implementations, the bed 50 can maintain an adequate water-level therein so that water can be supplied to the cultivator 60 at all times.

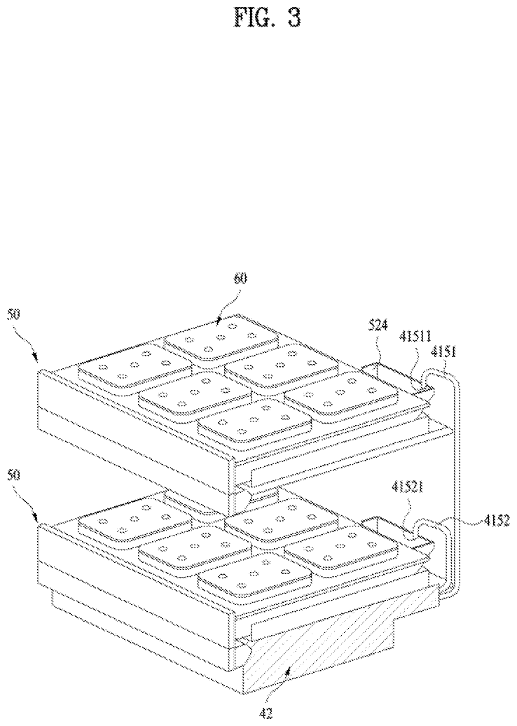

FIG. 3 is a perspective view showing an example of a cultivator seated on a bed in a plant cultivation apparatus.

As shown in FIG. 3, the plant cultivation apparatus 1 can include the bed 50, the water supply 40, and the cultivator 60 disposed inside the cabinet 10.

The plant cultivation apparatus 1 can include the bed 50 disposed inside the cabinet, the cultivator 60 seated on the bed and receiving therein a cultivation medium 64 in which at least a portion of the plant is received, and the water supply 40 disposed inside the cabinet and configured to supply water to the bed 50.

The water supply 40 can include a water supply casing 42 having storage, a supply pump, a flow sensor, a branching valve, and a connective channel as described below received therein.

The storage can store therein water to be supplied to the cultivator 60 for the plant.

As shown in FIG. 3, the water supply casing 42 can be disposed below the bed and can be coupled to the cabinet 10.

Due to the water supply casing 42, the storage, the supply pump, the flow sensor, the branching valve, and the connective channel are not exposed to the outside, thereby improving the reliability of water supply 40, and achieving neat outer appearance.

In some examples, the cultivator 60 can be seated on the bed. The nutrient liquid (hereinafter, water) from the water supply 40 can be fed to the cultivator 60 through the communication channel 411 which will be described later. The cultivator 60 can be constructed such that the water can be discharged to the storage through the communication channel 411.

Further, the cultivator 60 can include a plurality of cultivators disposed on a top face of the bed 50. Thus, the plurality of cultivators 60 can receive different types of plants, respectively. Thus, the different types of plants can be cultivated in the cultivation space S1.

In other words, the cultivator 60 can be provided to be adapted to a combination of various kinds of seeds and corresponding nutrients. The user can select a plant to be cultivated and cultivate the plant in the cultivator 60.

In some implementations, the cultivator 60 can be removably seated on the bed 50. Accordingly, the user can input the cultivation medium 64 containing the seeds of the plant therein into the cultivator 60 while the cultivator 60 is located out of the plant cultivation apparatus 1. Then, the user can seat the cultivator 60 on the bed 50 through one open face of the cabinet 10.

In some examples, when the plant grows and then a harvest timing arrives, the user can separate the cultivator 60 from the bed 50. Thus, the plant in the cultivator 60 can be easily harvested while the cultivator is located out of the plant cultivation apparatus 1, thereby increasing easiness and convenience of harvesting by the user.

Further, the cultivator 60 can have a shape extending from one side thereof to the opposite side thereof. A direction in which the cultivator 60 extends can be a first direction from the cultivation space S1 toward the door 20.

In some implementations, while being seated on the top face of the bed 50, the plurality of cultivators 60 can be arranged to be spaced apart from each other in the first direction in which the cultivator 60 extends and a second direction perpendicular to the first direction.

Hereinafter, for convenience of description, a direction in which the cultivator 60 extends is defined as the first direction, while a direction perpendicular to the first direction is defined as the second direction.

In some examples, the bed 50 can include a rectangular plate that partitions an inside of the cabinet 10. In some examples, the bed 50 can be seated into a retract-extend guide defined in each of both opposing side faces of the cabinet 10 in the retracting and extending manner.

A bed water collector 625 constructed to receive water through the water supply 40 can be formed in one side of the bed 50. The bed water collector 625 can be connected to the communication channel 411 disposed inside the bed 50, such that the water supplied to the bed water collector 625 can be continuously supplied to the cultivator 60.

The water supply 40 can include a first upper supply channel 4151 extending to the bed water collector 625 of the upper bed 50 and a first lower supply channel 4152 extending to the bed water collector 625 of the lower bed 50. The first upper supply channel 4151 and the first lower supply channel 4152 can be configured to supply the water to the upper bed 50 and the lower bed 50, respectively. The water supply 40 can have water discharge holes 41511 and 41521 defined respectively at positions corresponding to the bed water collectors 625. Thus, the water supplied from the first upper supply channel 4151 and the first lower supply channel 4152 can be directly inflowed to the bed water collectors 625.

Each of the first upper supply channel 4151 and the first lower supply channel 4152 can include a pipe made of metal such stainless steel or some other materials. Thus, each of the first upper supply channel 4151 and the first lower supply channel 4152 can be managed hygienically and can be maintained in a rigid manner to prevent clogging thereof due to deformation or bending of a flow path, and to improve the reliability of water supply.

A water supply structure in which the water is fed to the upper bed 50 and a water supply structure in which the water is fed to the lower bed 50 can be the same only except for a difference in a vertical position thereof. The water supplied to the bed water collector 625 can supply moisture to the cultivator 60 mounted on the bed 50.

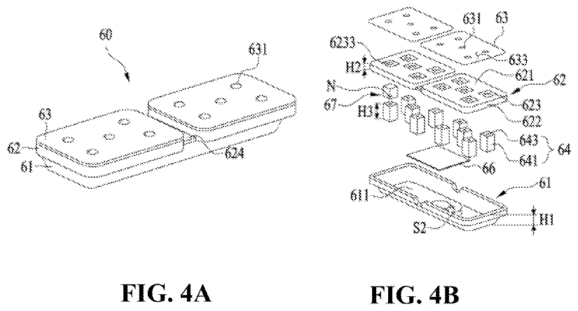

FIG. 4A is a perspective view showing an example of a cultivator in the plant cultivation apparatus. FIG. 4B is an exploded view showing an example of the cultivator in the plant cultivation apparatus.

As shown in FIGS. 4A and 4B, the cultivator 60 can include a cultivation vessel 61 seated on the bed 50 and constructed to have an open top, and a cover 62 for shielding the open top of the cultivation vessel 61.

The cultivation vessel 61 can be constructed to have the open top, and can be seated on the bed 50. Accordingly, the user can select the cultivator 60 corresponding to a type of the plant to be cultivated and can seat the selected cultivator 60 at a position on the bed 50 to start cultivation of the plant.

Further, the cultivation vessel 61 can include a bottom surface 611 of the cultivation vessel and can have a cultivation medium receiving space S2 defined therein and can be coupled to the cover 62.

Further, the cultivation vessel 61 can have a first communication hole 6135 defined therein through which water in the cultivation medium receiving space S2 is discharged to the communication channel 411, as will be described later. The cultivation medium receiving space S2 can receive water from the water supply 40 through the first communication hole 6135. The water in the cultivation medium receiving space S2 can be collected back into the water supply 40. Further, the first communication hole 6135 can be defined in the bottom surface 611 of the cultivation vessel 61 and communicate with the communication channel 411 disposed in the bed.

The cultivator 60 can include a cultivation filter 66 disposed on the bottom surface 611 of the cultivation vessel 61 for removing foreign substances from the water discharged or inflowing through the first communication hole 6135. The foreign material removed using the cultivation filter 66 can be a portion of the cultivation medium 64 produced in the plant growth process, or can be a portion of the root of the plant.

Further, the foreign material can be a portion of a stem or a leaf of a plant that is produced due to an upper water supply structure to be described later. The cultivation filter 66 can be configured to shield the first communication hole 6135, and to prevent inflow of foreign substances as produced in the cultivation medium receiving space into the water supply 40.

In some examples, the cultivation vessel 61 can have the cultivation medium receiving space S2 defined therein for receiving therein the cultivation medium 64 in which at least a portion of the plant is received. The cultivation medium 64 can be received in the cultivation medium receiving space S2 defined in the cultivation vessel 61. The cultivation medium 64 can extend vertically from the bottom surface 611 of the vessel toward the cover 62 by a predetermined vertical dimension H3.

Nutrients for the plant growth can be contained in the cultivation medium 64. When only water is supplied to the cultivation medium 64 without supply of additional components thereto, the plant growth can proceed at an adequate rate.

Further, the cultivation medium 64 can include a cultivation medium body 641 that defines the outer appearance of the cultivation medium 64 and a cultivation medium hole 643 that is defined at a top portion of the cultivation medium body. The cultivation medium 64 contains the seeds of the plant. The cultivation medium can be made of various materials capable of absorbing the water stored in the cultivation medium receiving space S2 and supplying the water to seeds or roots inside the cultivation medium 64.

In some examples, the cover 62 can cover the cultivation medium receiving space S2 of the cultivation vessel 61. A top of the cultivation vessel 61 is open. Thus, the cover 62 can be disposed at a top of the cultivation vessel and can be coupled to the cultivation vessel 61.

In some examples, the cultivation medium receiving space S2 can store therein water supplied to the cultivation medium 64. When the water is exposed to air out of the cultivator and to light from an artificial light source, reproduction of microorganisms in the water can become active, thereby adversely affecting the growth of the plant.

In order to help to prevent this situation, in some implementations, the cover 62 can cover the cultivation medium receiving space S2 of the cultivation vessel 61, so that the cultivation medium receiving space is prevented from being exposed to an environment out of the cultivator 60. Due to the cover 62, the water stored inside the cultivation medium receiving space S2 can be prevented from being exposed to light irradiated from the artificial light source disposed above the top of the cultivator 60. Contact of the water with the air outside the cultivator 60 can be prevented.

With the cover 62, the roots of the plant grown in the cultivation medium 64 may not be exposed to the light source, so that the growth of the plant can be improved.

The cover 62 can be coupled to the cultivation vessel 61 using a bolt-nut structure. However, the disclosure is not limited thereto. Hereinafter, as shown in the drawings, an example in which the cover 62 is coupled to the cultivation vessel 61 in a press-fitting manner is described.

In some examples, the plant cultivation apparatus 1 can include a nutrient feeder 67 located in the cultivation medium receiving space S2. The nutrient for the plant is received in the nutrient feeder 67

The nutrient feeder 67 can be disposed to be spaced apart from the bottom surface 611 of the cultivation vessel 61. When the nutrient feeder 67 is brought into contact with water stored in the cultivation medium receiving space S2, the nutrient therein can be mixed with the water and then the mixture can be supplied to the cultivation medium.

In some examples, the cover 62 can include a cultivation medium receiving portion 623 which is formed at a position corresponding to that of the cultivation medium 64 and into which an upper end of the cultivation medium is inserted. Due to the cultivation medium receiving portion 623, the cultivation medium 64 can be fixedly received inside the cultivation vessel 61 when the cover 62 is coupled to the cultivation vessel.

The cover 62 can have a predetermined vertical dimension H2 and can extend from a bottom to a top thereof. The cultivation medium receiving portion 623 can have a vertical dimension equal to the vertical dimension H2 of the cover 62 such that the upper end of the cultivation medium 64 can be received therein.

The number of the cultivation medium receiving portions 623 can correspond to the number of the cultivation mediums 64. In order to fix the position of the cultivation medium 64, the number of the cultivation medium receiving portions 623 can be greater than or equal to the number of the cultivation medium 64.

As shown in FIG. 4B, the cultivation medium receiving portion 623 can be defined in a top face of the cover. The cultivation medium receiving portion 623 can include a plurality of the cultivation medium receiving portions. The present disclosure is not necessarily limited thereto. A distance between adjacent ones of the plurality of cultivation medium receiving portions 623 can be appropriately designed according to the type of plant to be cultivated.

The cultivation medium receiving portion 623 can have a cover through-hole 6233 defined at a position thereof corresponding to a position of the cultivation medium 64 so as to expose at least a portion of a top face of the cultivation medium 64. The cover through-hole 6233 can extend through the top face of the cover 62.

A seed of the plant received in the cultivation medium hole 643 germinates. A stem of the plant can extend through the cover through-hole 6233 and can grow toward a space above the top of the cover 62. Therefore, for smooth growth of the plant, a diameter of the cover through-hole 6233 can be defined to be larger than a diameter of the cultivation medium hole 643.

That is, in a top view of the cultivator 60, the cover through-hole 6233 can be defined to expand along a radial direction of the cultivation medium hole 643. The diameter of the cover through-hole 6233 can be appropriately designed in consideration of the size of the plant being cultivated.

Further, a center of the cover through-hole 6233 can be positioned to correspond to a center of the cultivation medium hole 643. Thus, when the plant germinates and grows, and thus extends to be exposed to a space out of the cultivation medium 64, the plant can be recognized by the user due to the cover through-hole 6233.

In some examples, the cultivator 60 can further include an indicator 63 disposed above the top face of the cover 62 to minimize exposure of the cultivation medium 64. A seed name of the plant can be written on the indicator. The seed name of the plant can be marked on the indicator 63 so that the type of the plant grown in the cultivation space can be easily recognized by the user.

The indicator 63 can be constructed to cover the top face of the cover 62. As shown in the figure, the indicator 63 can include a plurality of indicators and can be disposed above the top face of the cover 62. The indicator 63 can be coupled to a remaining area of the cover 62 except for a cover coupler 624.

Thus, in the top view of the cultivator 60, a top face 633 of the indicator 63 can be exposed to the outside, and a top face of the cover except for the cover coupler 624 may not be exposed to the outside.

The indicator 63 can have an indicator hole 631 defined therein at a position corresponding to that of the cover through-hole 6233 and can have a diameter smaller than the diameter of the cover through-hole 6233, so that exposure of the cultivation medium 64 to the outside can be prevented. The plant can grow and extend through the indication hole 631 and toward a space above the top of the cultivator 60.

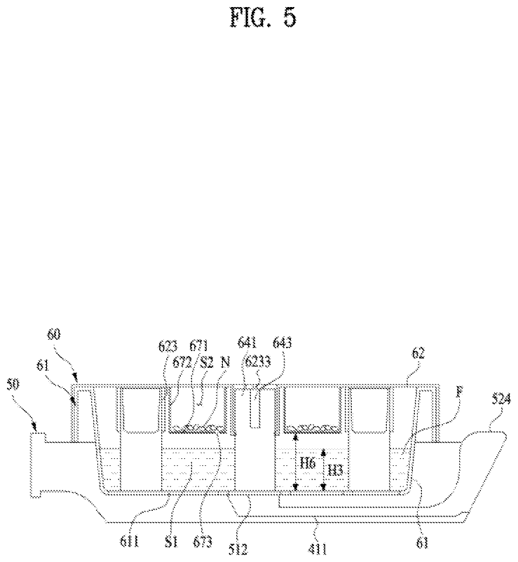

FIG. 5 is a side view showing an example of a cultivator including the nutrient feeder 67 in the plant cultivation apparatus 1.

The nutrient feeder 67 can be disposed to be spaced apart from the cultivation medium receiving portion 623, and can be coupled to the bottom surface of the cover 62.

A bottom portion 671 of the nutrient feeder 67 can be spaced apart from the bottom surface 611 of the cultivation vessel 61 by a predefined spacing H6. The nutrient feeder 67 can have a nutrient storage space S3 defined therein, so that nutrient N for the plant growth can be stored in the nutrient storage space S3.

Further, the nutrient feeder 67 can have a nutrient feeding hole 673 defined therein communicating with the cultivation medium receiving space S2. The nutrient feeder 67 can be constructed such that when the water stored in the cultivation medium receiving space S2 flows into the nutrient feeder 67, the water together with the nutrient N can be discharged through the nutrient feeding hole 673.

In some implementations, one face of the nutrient feeder 67 facing toward the cultivation medium receiving space S2 can be made of a mesh material, so that the nutrient N can be dissolved in the water which may, in turn, be supplied to the cultivation medium receiving space S2.

In some implementations, the nutrient N can include water-soluble solid dissolved in the water. The disclosure is not necessarily limited thereto. As long as the nutrient N is mixed with the water flowing into the nutrient storage space S3 and the mixture is discharged to the cultivation medium receiving space S2, a type of the nutrient N may not be particularly limited.

Further, the nutrient feeder 67 can include a side face 672 extending from the cover 62 toward the bottom surface 611 of the cultivation vessel 61, and the bottom portion 671 extending from the side face 672 in a horizontal direction. The nutrient feeding hole 673 can be defined in the bottom portion 671.

The side face 672 and the bottom portion 671 together with the bottom surface of the cover 62 can define the nutrient storage space S3. A size of each of the side face 672 and the bottom portion 671 can be appropriately set according to a size of the plant, and a size of each of the cultivation medium, the cultivation medium vessel, and the cover 62.

The nutrient feeding hole 673 can be defined in the side face 672. The nutrient feeder 67 can include a plurality of feeders. The nutrient feeding hole 673 can include a plurality of holes.

The bottom portion 671 of the nutrient feeder 67 can be spaced apart from the bottom surface 611 of the cultivation vessel 61 by the predefined spacing H6. When the nutrient feeding hole 673 is defined in the bottom portion 671, the nutrient feeding hole 673 can be spaced from the bottom surface 611 of the cultivation vessel 61 by the predefined spacing H6.

When the nutrient N includes a solid nutrient, a size of the solid can be larger than a size of the nutrient feeding hole 673. Thus, when water does not flow into the nutrient feeder 67, the nutrient N may not flow through the nutrient feeding hole 673.

A distance between both opposing side faces 672 of the nutrient feeder 67 can be defined as a diameter thereof. The distance can be defined to be smaller than a distance between adjacent one of a plurality of cultivation mediums 64.

In some examples, the first water supply channel 415 can include a first lower supply channel 4152 and a first upper supply channel 4151. The first water supply channel 415 can include the communication channel 411 which is disposed in the bed 50 and communicates with the first communication hole 6135, and supplies water from the bed water collector 625 to the first communication hole 6135 or collects the water from the bed water collector 625.

Further, the water supplied to the cultivator 60 through the communication channel 411 can be continuously supplied to the cultivator 60. In detail, the communication channel 411 can communicate with the bed water collector 625. The communication channel 411 can communicate with the storage included in the water supply 40 which will be described later, so that the water discharged from the cultivator 60 can be discharged to the storage through the communication channel 411.

Further, a predetermined vertical level H3 of the water F supplied from the first water supply channel 415 to the cultivation medium receiving space S2 through the communication channel 411 can be defined.

When the water is continuously supplied from the first water supply channel 415 to the cultivation medium receiving space S2, the vertical level H3 of the water F can be increased. When the vertical level of the water is higher than the vertical level H6 of the nutrient feeding hole 673, the water inflows into the nutrient storage space S3 and thus the nutrient N can be dissolved in the water. The dissolved nutrient N can be fed back to the cultivation medium 64 through the nutrient feeding hole 673.

Thus, due to the above structure, the plant cultivation apparatus 1 adjusts an inflow amount of water supplied into the cultivation medium receiving space S2 to provide additional nutrient supply such that the nutrient N from the nutrient feeder 67 can be supplied to the plant.

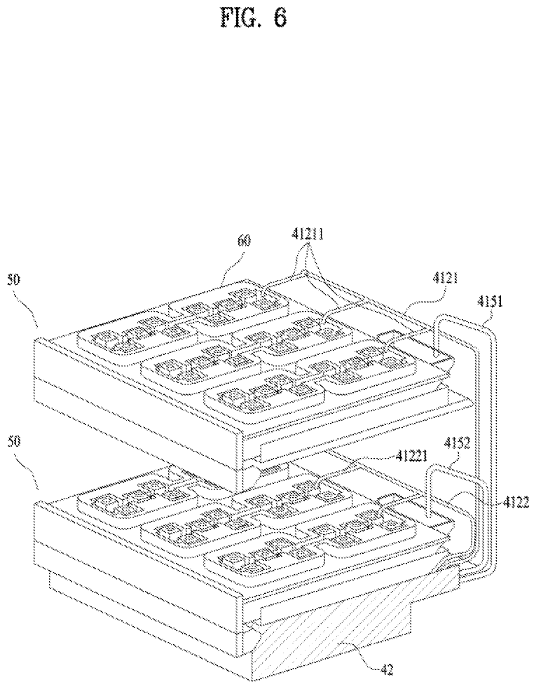

FIG. 6 is a perspective view showing an example of a cultivator in the plant cultivation apparatus. Hereinafter, descriptions duplicate with those of the above-described structure will be omitted.

In the plant cultivation apparatus 1, the cultivator 60 can be seated on the bed 50 and can include the cultivation vessel 61 having an open top, and a cover 62 for shielding the open top of the cultivation vessel 61.

Further, the cultivator can further include a cover channel 65 disposed in a top face of the cultivator 60 for receiving water to be supplied to the plant. The water supply 40 can include a second water supply channel 412.

The second water supply channel 412 can be constructed such that at least a portion of the second water supply channel 412 is positioned above the cover channel 65 such that the water to is fed to the cover channel 65 therethrough.

Further, the cover channel 65 can be disposed in the top face of the cover. The cover channel 65 can be constructed to communicate with the inside of the cultivator 60 so that the water supplied from the second water supply channel 412 is guided to the cultivation medium therethrough.

The water supply 40 can include a supply channel that supplies water to the cultivator 60, and storage that supplies water to the cultivator 60 and collects the water therefrom and stores the collected water therein.

As shown in FIG. 3, the water supply 40 can be configured to supply water to the bed water collector 625 of the bed 50 through the first water supply channel 415.

Further, as shown in FIG. 6, the water supply 40 can be configured to supply water to the cover channel 65 through the second water supply channel 412.

Specifically, the second water supply channel 412 can include a second upper supply channel 4121 for supplying water to the cover channel 65 of the upper bed 50 among the plurality of beds 50, and a second lower supply channel 4122 that supplies water to the cover channel 65 of the lower bed 50.

Each of the second upper supply channel 4121 and the second lower supply channel 4122 can be disposed independently, and can extend to face toward each of the cover channels 65, so that water for plant growth can be supplied thereto. The second upper supply channel 4121 and the second lower supply channel 4122 can include pipes, tubes, or the like that can guide water therethrough.

The second water supply channel 412 can be connected to the storage and can extend upward. The water flows from the storage into the second water supply channel 412 along which the water flows upward.

Further, the second upper supply channel 4121 and the second lower supply channel 4122 can have a second upper supply branch channel 41211 and a second lower supply branch channel 41221 facing toward upper and lower cover channels 65 and supplying water to the upper and lower cover channels 65, respectively.

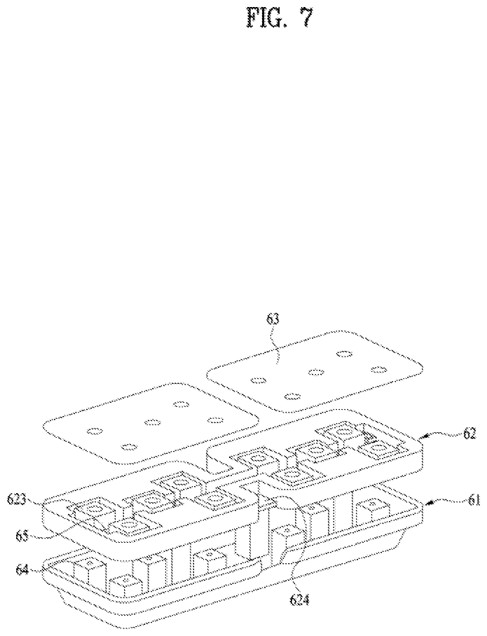

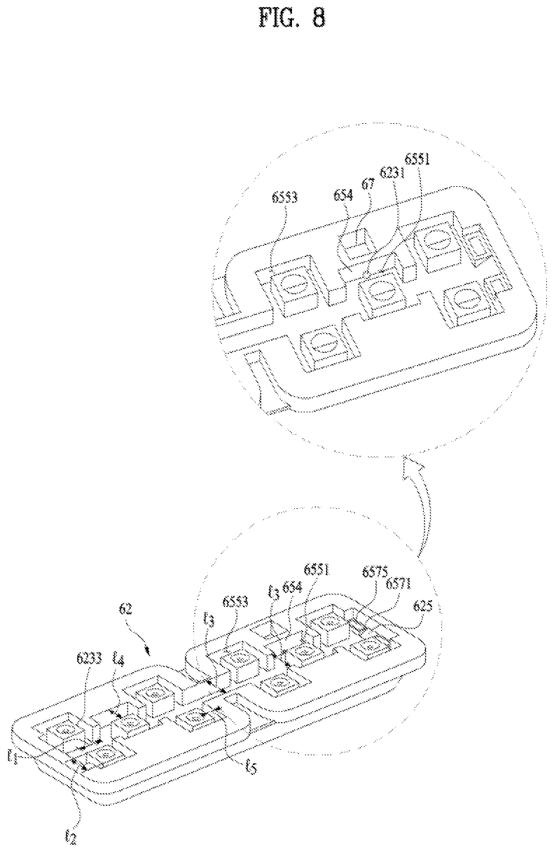

FIG. 7 is an exploded view showing an example of a cultivator in the plant cultivation apparatus. FIG. 8 is a perspective view showing an example of a cultivator in the plant cultivation apparatus. Hereinafter, descriptions duplicate with those of the above-described structure will be omitted.

The cover channel 65 can be constructed to overlap with at least a portion of the cultivation medium receiving portion 623. In other words, the cover channel 65 can be constructed such that one face of the cultivation medium receiving portion 623 is exposed to the inside of the cover channel 65.

Further, the cultivation medium receiving portion 623 can have a second inflow hole 6232 for providing water from the cover channel 65 to the cultivation medium 64. The second inflow hole 6232 can be defined to be exposed to the inside of the cover channel 65. The water supplied from the supply channel to the cover channel 65 is received in the cover channel 65, and flows into the second inflow hole 6232, and then is supplied to the cultivation medium 64.

As shown in FIG. 8, the cover channel 65 can include a first cover channel 6551 extending from one side to the opposite side of the cover and a second cover channel 6553 branching from the first cover channel 6551. A direction in which the first cover channel 6551 extends can be a direction in which the cultivator 60 extends toward the door 20 as described above.

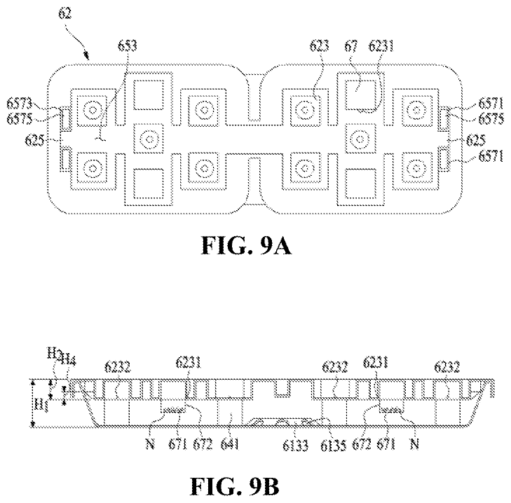

Further, a direction in which the second cover channel 6553 branches from the first cover channel 6551 and extends can be inclined relative to a direction in which the first cover channel 6551 extends. As shown in FIGS. 9A and 9B, the direction in which the second cover channel 6553 branches from the first cover channel 6551 and extends can be perpendicular to the direction in which the first cover channel 6551 extends.

Further, the cover channel 65 can be defined by depressing a portion of the top face of the cover 62. The cultivation medium receiving portion 623 can protrude upward from a bottom surface 653 of the cover channel 65 and can be positioned inside the cover channel 65.

As described above, the cultivation medium 64 can include a plurality of mediums. The cultivation medium receiving portion 623 can include a plurality of cultivation medium receiving portions. Thus, the cover channel 65 can extend so as to connect a plurality of points corresponding to positions of the plurality of cultivation medium 64 to each other.

Further, the plurality of cultivation medium receiving portions 623 can be constructed to be positioned inside the first cover channel 6551 and the second cover channel 6553. Accordingly, the second inflow hole 6232 through which the water stored in the cover channel 65 flows into the inside of the cultivation medium receiving portion 623 can include a plurality of second inflow holes arranged along a circumference of the cultivation medium receiving portion 623. Thus, the water in the cover channel 65 can be more smoothly supplied to the cultivation medium 64.

The second inflow hole 6232 can be in contact with the bottom surface 653 of the cover channel 65 so that the water received in the cover channel 65 can flow into the second inflow hole.

The cultivation medium 64 can be in contact with the inner face of the cultivation medium receiving portion 623. The upper end of the cultivation medium 64 can be inserted into the cultivation medium receiving portion. The second inflow hole 6232 can be constructed to extend from the inner face of the cultivation medium receiving portion 623 toward the cover channel 65 to guide the water received in the cover channel 65 to the cultivation medium 64.

In some examples, a longitudinal direction 11 of the cultivation medium receiving portion 623 along an extending direction of the first cover channel 6551 can be equal to a transverse length 12 of the cultivation medium receiving portion 623 perpendicular to the extending direction of the first cover channel 6551. The longitudinal and transverse lengths 11 and 12 of the cultivation medium receiving portion 623 can be sized based on a shape of the cultivation medium 64.

A width 13 of the cover channel 65 perpendicular to the extending direction of the first cover channel 6551 can be defined to be larger than each of the transverse lengths 11 and 12 of the cultivation medium receiving portion 623. Thus, the flow of water along the cover channel 65 can be achieved smoothly.

Further, the cultivation medium receiving portion 623 can be spaced apart from a sidewall 654 of the cover channel 65 by a predefined spacing 15. The predefined spacing 15 between the sidewalls 654 of the cover channel 65 and the cultivation medium receiving portion 623 can be sized so that the flow of water along the cover channel 65 is not too fast.

The predefined spacing 15 can be appropriately designed based on a vertical dimension of the cover channel 65 in the top face of the cover 62, a size of the cultivation medium receiving portion 623, and an amount of water supplied to the cover channel 65.

Further, the sidewall 654 of the cover channel 65 can be formed such that a portion thereof facing toward the cultivation medium receiving portion 623 is recessed in a direction away from the cultivation medium receiving portion 623.

In other words, the portion of the sidewall 654 of the cover channel 65 facing toward the cultivation medium receiving portion 623 closest thereto can be recessed so as to be spaced from the cultivation medium receiving portion 623 by the predefined spacing 14, thereby defining a predetermined space between the cultivation medium receiving portion 623 and the sidewall.

Thus, the water moving around the cultivation medium receiving portion 623 can be received in a larger amount in a space between the cultivation medium receiving portion 623 and the sidewall 654 of the cover channel 65.

Thus, a time duration for which the water received in the space between the cultivation medium receiving portion 623 and the sidewall 654 of the cover channel 65 is in contact with the cultivation medium receiving portion 623 can be increased. Thus, a time duration for which the water flows into the second inflow hole 6232 of the cultivation medium receiving portion 623 can be increased.

In some examples, the cover channel 65 can have a first inflow hole 6231 which communicates with the nutrient storage space S3 inside the nutrient feeder 67. The water can be supplied to the nutrient feeder 67 through the first inflow hole 6231.

The water supplied from the cover channel 65 through the first inflow hole 6231 can flow into the nutrient storage space S3. The nutrient N can be dissolved in and missed with the water. The mixture solution can flow through the nutrient feeding hole 673.

Further, as a vertical dimension from the bottom surface 653 of the cover channel 65 to the first inflow hole 6231 is smaller, the inflow of water from the cover channel 65 to the first inflow hole 6231 can be achieved more efficiently. Accordingly, the first inflow hole 6231 can be in contact with the bottom surface 653 of the cover channel 65 so that the water received in the cover channel 65 can flow into the first inflow hole.

In other words, a portion of a diameter of one end of the first inflow hole 6231 exposed toward the inside of the cover channel 65 can be in contact with the bottom surface 653 of the cover channel 65.

Thus, after the supply of water from the second water supply channel 412 is finished, the water supplied to the cover channel 65 does not remain on the bottom surface 653 of the cover channel 65 but an entire amount thereof flows into the second inflow hole 6232. Then, the water together with the nutrient N can be supplied to the cultivation medium receiving space S2.

In some examples, the cover channel 65 can include protrusions 6571 and 6573 protruding upward from the bottom surface 653 of the cover channel 65. The protrusions 6571 and 6573 can include a first protrusion 6571 positioned on one side of the cover 62 and positioned closer to the water supply 40 than the cultivation medium receiving portion 623 is.

Further, the protrusions 6571 and 6573 can further include a second protrusion 6573 located on the opposite side of the cover. The first protrusion 6571 and the second protrusion 6573 can be respectively disposed at one side and the opposite side in the extending direction of the first cover channel.

Because the first protrusion 6571 and the second protrusion 6573 are disposed at one side and the opposite side, respectively, a flow rate of water moving inside the cover channel 65 can be kept constant.

The cover channel 65 can include a third inflow hole 6575 defined in a top face of each of the protrusions 6571 and 6573 and communicating with the inside of the cultivation vessel. In other words, the third inflow hole 6575 can be constructed to communicate with the cultivation medium receiving space S2. Water from the cover channel 65 can flow into the cultivation medium 64 through the third inflow hole 6575.

Further, when the amount of water supplied from the supply channel to the cover channel 65 is too large, the water supplied to the cover channel 65 through the third inflow hole 6575 can be guided to the cultivation medium receiving space S2.

Further, depending on the type of the plant cultivated in the plant cultivation apparatus 1, the amount of the water supplied to the cultivator 60 can be greater than an amount in which the cover channel 65 can receive the water.

The water can be supplied to the cultivation medium through the first inflow hole 6231 communicating with the nutrient feeder 67, the second inflow hole 6232 defined in the cultivation medium receiving portion, and the third inflow hole 6575 defined in each of the protrusions 6571 and 6573.

FIGS. 9A and 9B are a top face view and a side view showing an example of a cultivator in the plant cultivation apparatus. FIG. 9A shows a top view of the cultivator 60. FIG. 9B shows a side view of the cultivator 60. Hereinafter, descriptions duplicate with those of the above-described structures will be omitted.

In the plant cultivation apparatus 1, the nutrient feeder 67 can be constructed to protrude upward from the bottom surface 653 of the cover channel 65 and to be spaced apart from the cultivation medium receiving portion 623.

Specifically, a second cover channel 6553 of the cover channel 65 can define a channel along the circumference of the nutrient feeder 67. A plurality of first inflow holes 6231 can be arranged along the circumference of the nutrient feeder 67.

That is, the first inflow hole 6231 can extend through the side face 672 of the nutrient feeder 67, so that the cover channel 65 and the nutrient storage space S3 communicate with each other via the first inflow hole 6231.

The first inflow holes 6231 can include a plurality of holes. Thus, the water supplied to the cover channel 65 can efficiently flow into the nutrient storage space S3. Thus, the nutrient N can be efficiently supplied to the cultivation medium 64 through the nutrient feeding hole 673.

A size of the nutrient feeder 67 can be defined to correspond to a size of the cultivation medium receiving portion 623. The nutrient feeder 67 can be constructed to be spaced apart from the cultivation medium receiving portion 623.

In some examples, the first inflow hole 6231 can be defined to contact the bottom surface 653 of the cover channel 65. In some cases, the second inflow hole 6232 can be disposed to be spaced apart from the bottom surface 653 of the cover channel 65, so that a predetermined vertical spacing can be defined between the bottom surface 653 of the cover channel and the second inflow hole 6232.

This is because the nutrient N can be efficiently supplied to the cultivation medium 64 when the water supplied to the cover channel 65 flows into the first inflow hole 6231 rather than when the water supplied to the cover channel 65 flows into the second inflow hole 6232.

In some examples, the supply channel can have discharge holes 41511 and 41521 through which water is discharged to the cover channel 65. The cover 62 can include a water collector 625 which can be located below the discharge holes 41511 and 41521. Thus, the water discharged from the discharge holes 41511 and 41521 can be supplied to the water collector 625. The cover channel 65 can be constructed to be connected to the water collector 625 and to receive water therefrom.

Further, the water collector 625 can be disposed at each of one side and the opposite side in the direction in which the cover channel 65 extends. The first protrusion 6571 can include a pair of protrusions. The water collector 625 can be positioned between the pair of the first protrusions 6571 and can collect the water supplied from the discharge holes 41511 and 41521 and guide the collected water to the cover channel 65.

Further, the water collector 625 can have a predetermined vertical dimension H4 based on the bottom surface 653 of the cover channel 65. The water collector 625 can be inclined such that a vertical level thereof is lowered as the water collector 625 extends toward the cover channel 65. One end thereof connected to the cover channel 65 together with the bottom surface 653 of the cover channel 65 can define a continuous face.

When the vertical dimension of the discharge holes 41511 and 41521 from the bottom surface 653 of the cover channel 65 is excessively larger, water falling to the water collector 625 can flow out of the cover channel 65.

However, due to the structure in which the water collector 625 has the inclination such that a vertical level thereof is lowered as the water collector 625 extends toward the cover channel 65, the water collector 625 can minimize water leakage to the outside of the cover channel 65 while stably guiding the water toward the cover channel 65.

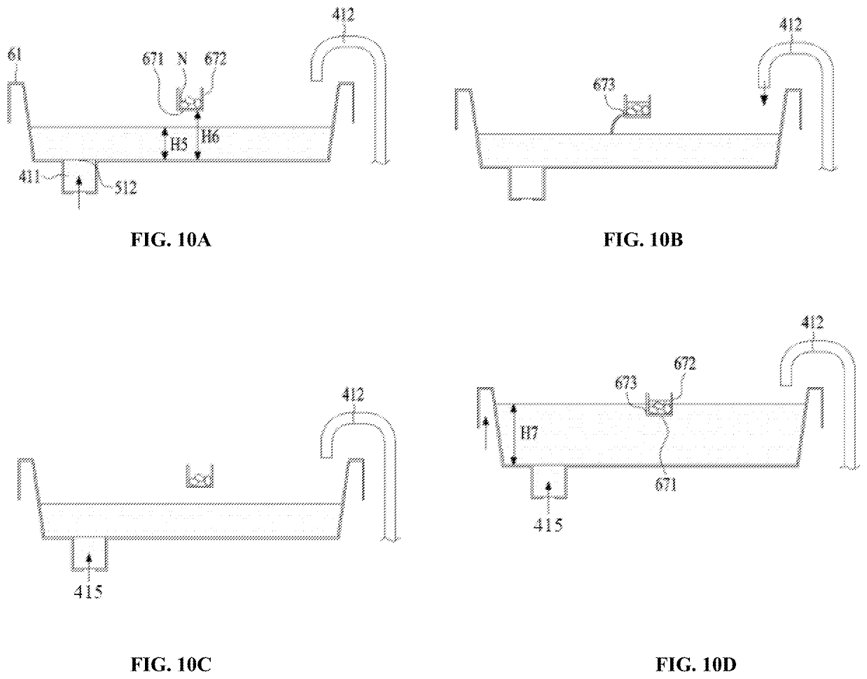

FIGS. 10A to 10D are diagrams showing an example of a water supply process of the plant cultivation apparatus. Hereinafter, descriptions duplicate with those of the above-described structures will be omitted.

FIGS. 10A and 10B show the process of supplying water to the nutrient storage space S3 of the nutrient feeder 67 through the second water supply channel 412. The structures of the cover 62 and the cover channel 65 are the same as the structures shown in FIGS. 9A and 9B. Thus, the structures of the cover 62 and the cover channel 65 are omitted from FIGS. 10A to 10D. Hereinafter, descriptions will be made while the structures of the cover 62 and the cover channel 65 are omitted.

In some examples, a vertical level of a component can be defined as a vertical dimension from the bottom surface 611 of the cultivation vessel 61.

The plant cultivation apparatus 1 can further include a controller 90 for controlling the water supply 40. The controller 90 can be configured to control a supply pump that controls the supply of water in the water supply 40, and a branching valve that controls the opening and closing of the first water supply channel 415 and the second water supply channel 412. The controller 90 may include an electric circuit, an electronic controller, a processor, or the like. In some cases, the controller 90 may be provided separately from the cabinet 10.

In some examples, as shown in FIG. 10A, in a state where additional nutrient N is not required, water is not supplied to the nutrient feeder 67, and water is supplied from the communication channel 411 to the cultivation medium receiving space S2 through the first water supply channel 415.

In this case, the controller 90 can block the second water supply channel 412 and can allow the water to be supplied to the cultivation medium receiving space S2 through the first water supply channel 415. In other words, the controller 90 can adjust the branching valve to supply water to the cultivator 60 selectively through one of the first water supply channel 415 and the second water supply channel 412.

When water is supplied to the cultivation medium receiving space S2, a vertical level H5 of the water-surface of the cultivation medium receiving space S2 can be lower than a vertical level H6 of the nutrient feeding hole 673. Accordingly, it can be prevented that the water in the cultivation medium receiving space S2 flows into the nutrient feeder 67, and thus the nutrient N is dissolved in water and thus the mixed solution flows through the nutrient feeding hole 673.

As shown in FIG. 10B, when additional nutrient is needed in the cultivation medium 64, the controller 90 can control the water supply 40 to block the first water supply channel 415 and allow the water to be supplied into the cover channel 65 through the second water supply channel 412.

In this case, water flows into the nutrient storage space S3 in the nutrient feeder 67 and thus the nutrient N in the nutrient feeder 67 is dissolved in and mixed with water and thus the mixed solution flows into the cultivation medium receiving space S2.

In some examples, as shown in FIG. 10C, in a state where additional nutrient N is not required, water is not supplied to the nutrient feeder 67, and water from the communication channel 411 is supplied to the cultivation medium receiving space S2 through the first water supply channel 415. The supply schemes of the water to the cultivation medium receiving space in FIGS. 10A and 10B can be the same as each other.

Further, in FIG. 10C, when water is supplied to the cultivation medium receiving space S2, the vertical level H5 of the water-surface of the cultivation medium receiving space S2 can be lower than the vertical level H6 of the nutrient feeding hole 673. Accordingly, it can be prevented that the water in the cultivation medium receiving space S2 flows into the nutrient feeder 67, and thus the nutrient N is dissolved in water and thus the mixed solution flows through the nutrient feeding hole 673.

In some examples, as shown in FIG. 10D, when it is determined that the supply of additional nutrient N is necessary, the water supply can be controlled so that the water is supplied to the first water supply channel 415 such that a vertical level H7 of the water-surface in the cultivation medium receiving space S2 is higher than the vertical level H6 of the nutrient feeding hole.

As will be described later, in FIGS. 10A and 10C, the controller 90 can control the water supply 40 to perform a general mode S100. Further, in FIG. 10B, the controller 90 can control the water supply 40 to perform an upper water supply mode S340. Further, in FIG. 10D, the controller 90 controls the water supply 40 to perform an additional water supply mode S330.

The upper water supply mode S340 is the same as the additional water supply mode S330 in that in both modes, the water is supplied from the water supply 40 to the nutrient feeder 67. The additional water supply mode S330 can be different from the upper water supply mode S340 in that the vertical level of the water in the cultivation medium receiving space S2 in the additional water supply mode S330 is higher than that in the upper water supply mode S340.

That is, the additional water supply mode S330 can be performed when it is necessary to additionally supply the amount of water supplied to the cultivation medium 64 based on the type of the plant.

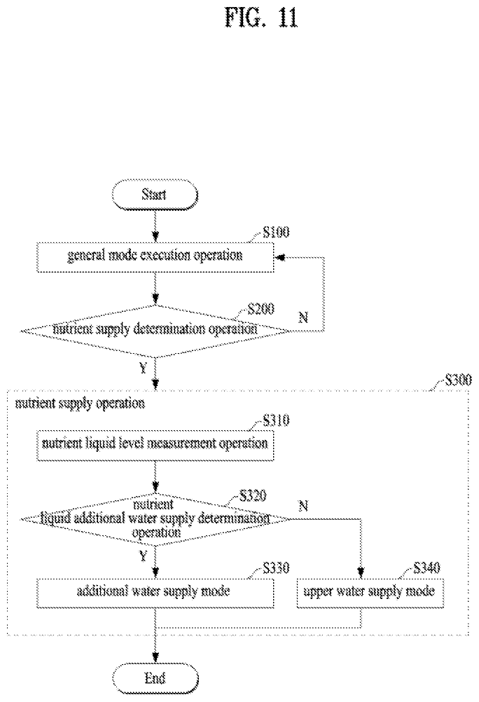

FIG. 11 is a view showing a control mode performed by the controller in the plant cultivation apparatus. Hereinafter, descriptions duplicate with those of the above-described structures will be omitted.

The controller 90 can be configured to control the water supply 40 to perform the general mode S100 as described above in a general mode execution operation S100 to supply the water to the cultivation medium 64. After the general mode execution operation S100, the controller 90 can perform a nutrient supply determination operation S200 to determine whether it is necessary to supply additional nutrient N to the cultivation medium 64.

A result of the nutrient supply determination operation S200 can be determined based on the user's input or a growth stage of the plant stored in the memory.

When it is determined that there is no need for additional nutrient supply in the nutrient supply determination operation S200, the controller 90 can perform the general mode execution operation S100.

In some examples, when it is determined that additional nutrient supply is necessary in the nutrient supply determination operation S200, the controller 90 can control the water supply 40 to perform a nutrient supply operation S300 to supply water to the nutrient feeder 67.

The controller 90 can perform a nutrient liquid level measurement operation S310 for measuring the vertical level of the water-surface using a sensor for measuring a vertical level of a water surface in the cultivation medium receiving space S2.

After the nutrient liquid level measurement operation S310, it can be determined, in the nutrient liquid additional water supply determination operation S320, that it is necessary to increase the vertical level H7 of the water-surface to be higher than the vertical level H7 of the nutrient feeding hole. In this case, the controller can perform the additional water supply mode S330.

In some examples, after the nutrient liquid level measurement operation S310, it can be determined, in the nutrient liquid additional water supply determination operation S320, that it is not necessary to increase the vertical level H7 of the water-surface to be higher than the vertical level H7 of the nutrient feeding hole. In this case, the controller 90 can perform the upper water supply mode S340.

In this way, the controller 90 can control the water supply 40 to supply the nutrient based on the growth stage of the plant. Thus, the user's convenience and the efficiency of the plant cultivation can be increased.

Although various implementations of the present disclosure have been described in detail, those of ordinary skill in the art to which the present disclosure pertains can make various modifications to the above-described various implementations without departing from the scope of the present disclosure. The scope of the present disclosure should not be limited to the described various implementations and should be defined by the claims to be described later, and equivalents to the claims.

What is claimed is:

1. A plant cultivation apparatus comprising:
a cabinet;
a bed disposed in the cabinet;
a cultivator configured to be disposed on the bed and to accommodate a cultivation medium therein, the cultivation medium being configured to accommodate at least portion of a plant; and
a water supply disposed at the cabinet and configured to supply water to the cultivator,
wherein the cultivator comprises:
a cultivation vessel that is configured to be disposed on the bed and defines a cultivation medium receiving space configured to accommodate the cultivation medium, the cultivation vessel being configured to receive water supplied from the water supply and to supply the water to the cultivation medium in the cultivation medium receiving space, and
a nutrient feeder that is disposed in the cultivation medium receiving space and spaced apart from a bottom surface of the cultivation vessel, the nutrient feeder being configured to accommodate a nutrient for the plant, and
wherein the cultivator is configured to bring the water inside the cultivation medium receiving space into contact with the nutrient of the nutrient feeder and to supply the nutrient mixed with the water to the cultivation medium.

2. The plant cultivation apparatus of claim 1, wherein the water supply includes a first water supply channel that extends toward the bed and configured to discharge water to the cultivation vessel, and
wherein the cultivation vessel defines a first communication hole configured to supply the water discharged from the first water supply channel into the cultivation medium receiving space.

3. The plant cultivation apparatus of claim 1, wherein the nutrient feeder defines a nutrient feeding hole that is in fluid communication with an inside of the nutrient feeder and the cultivation medium receiving space, and
wherein the nutrient feeding hole is configured to supply the water in the cultivation medium receiving space into the inside of the nutrient feeder to thereby mix the water with the nutrient.

4. The plant cultivation apparatus of claim 2, wherein the cultivation vessel has an open top that exposes the cultivation medium receiving space therethrough,
wherein the cultivator further comprises a cover configured to be disposed on the open top of the cultivation vessel and to cover the cultivation medium receiving space, and
wherein the cover has:
a cover channel defined at a top surface of the cover and configured to receive the water supplied from the water supply, and
a first inflow hole that is defined in the cover channel and in fluid communication with the inside of the nutrient feeder, the first inflow hole being configured to supply the water to the nutrient feeder.

5. The plant cultivation apparatus of claim 4, wherein the cover channel is recessed from a portion of the top surface of the cover, and
wherein the cover further comprises a cultivation medium receiving portion that is disposed in the cover channel, that protrudes upward relative to a bottom surface of the cover channel, and that is configured to accommodate an upper end of the cultivation medium in the cultivation medium receiving space.

6. The plant cultivation apparatus of claim 5, wherein at least a portion of the first inflow hole is defined by the bottom surface of the cover channel.

7. The plant cultivation apparatus of claim 5, wherein the nutrient feeder is disposed at the cover and is spaced apart from the cultivation medium receiving portion, and
wherein the first inflow hole is defined at a periphery of the nutrient feeder.

8. The plant cultivation apparatus of claim 7, wherein the nutrient feeder includes:
a side surface that extends from the cover toward the bottom surface of the cultivation vessel; and
a bottom portion that is connected to the side surface and defines a nutrient feeding hole in fluid communication with the cultivation medium receiving space, and
wherein the first inflow hole passes through the side surface of the nutrient feeder and is in fluid communication with the inside of the nutrient feeder.

9. The plant cultivation apparatus of claim 8, wherein the water supply further includes a second water supply channel that is located above at least a part of the cover channel and configured to supply water to the cover channel to thereby supply the water to the nutrient feeder through the first inflow hole.

10. The plant cultivation apparatus of claim 9, further comprising a controller configured to control the water supply, and
wherein the controller is configured to, in a general mode, control the water supply to supply water to the cultivation medium receiving space through the first water supply channel to thereby raise a water surface of water in the cultivation medium receiving space to a first level that is lower than a vertical level of the nutrient feeder such that the nutrient feeder is positioned above the water surface.

11. The plant cultivation apparatus of claim 10, wherein the water supply is configured to supply water to the cultivator selectively through one of the first water supply channel or the second water supply channel, and
wherein the controller is configured to, in the general mode, block the second water supply channel and control the water supply to supply water to the cultivation medium receiving space through the first water supply channel.

12. The plant cultivation apparatus of claim 10, wherein the controller is configured to, in an additional water supply mode, control the water supply to supply water to the cultivation medium receiving space through the first water supply channel to thereby raise the water surface in the cultivation medium receiving space to a second level that is higher than or equal to a vertical level of the nutrient feeding hole such that the nutrient of the nutrient feeder is mixed with the water supplied through the nutrient feeding hole and fed to the cultivation medium.

13. The plant cultivation apparatus of claim 10, wherein the controller is configured to, in an upper water supply mode, block the first water supply channel and control the water supply to supply water to the cover channel through the second water supply channel to thereby supply the water to the nutrient feeder through the cover channel such that a mixture of the water and the nutrient in the nutrient feeder is supplied to the cultivation medium.

14. The plant cultivation apparatus of claim 1, wherein the water supply comprises a pipe that is made of metal.

15. The plant cultivation apparatus of claim 1, wherein the cultivation vessel defines a communication hole at the bottom surface and an open top facing the bottom surface, the communication hole being in fluid communication with the cultivation medium receiving space.

16. The plant cultivation apparatus of claim 15, wherein the water supply comprises:
a first pipe configured to supply water to the communication hole to thereby raise a water surface of water in the cultivation vessel above a bottom of the nutrient feeder; and
a second pipe configured to supply water to the nutrient feeder through the open top of the cultivation vessel while the water surface of water in the cultivation vessel is lower than the bottom of the nutrient feeder.

17. The plant cultivation apparatus of claim 16, wherein the cultivator further comprises a cover configured to cover the open top of the cultivation vessel, the cover defining a cover channel recessed from an upper surface of the cover toward the bottom surface and configured guide the water supplied through the second pipe toward the nutrient feeder.

18. The plant cultivation apparatus of claim 17, wherein the cultivator is configured to accommodate the cultivation medium vertically between the cover and the cultivation vessel.

19. The plant cultivation apparatus of claim 17, wherein the nutrient feeder is recessed from the upper surface of the cover and spaced apart from the cover channel, and
wherein the cover further defines a first inflow hole that is in fluid communication with the nutrient feeder and the cover channel.

20. The plant cultivation apparatus of claim 19, wherein the bottom of the nutrient feeder is disposed vertically below a bottom surface of the cover channel.
